(19) United States
(12) Patent Application Publication
(10) Pub. No.: US 2016/0150530 A1
(43) Pub. Date: May 26, 2016

(54) NETWORK CONTROL METHOD, COMMUNICATION APPARATUS AND COMMUNICATION SYSTEM

(71) Applicant: FUJITSU LIMITED, Kawasaki-shi (JP)

(72) Inventor: Fumio FUJISAKI, Yokohama (JP)

(21) Appl. No.: 14/921,857

(22) Filed: Oct. 23, 2015

(30) Foreign Application Priority Data
Nov. 26, 2014 (JP) 2014-238356

(51) Int. Cl. H04W 72/04; H04W 36/00

(52) U.S. Cl. CPC H04W 72/0433; H04W 36/005

(57) ABSTRACT

A network control method of a communication system into which a first node supporting a first radio communication standard, a second node supporting a second radio communication standard, the second node connecting with the first node, and a communication apparatus connected with the first node are formed, the network control method includes: transmitting a first control signal bound for the first node, associated with a first terminal supporting the first radio communication standard, to the first node; generating a second control signal bound for the first node, the second control signal including a third control signal bound for the second node, associated with a second terminal supporting the second radio communication standard, and a fourth control signal having a transmission instruction for transmitting the third control signal to the second node; and transmitting the second control signal to the first node, by the communication apparatus.

### CROSS-REFERENCE TO RELATED APPLICATION

This application is based upon and claims the benefit of priority from the prior Japanese Patent Application No. 2014-238356, filed on Nov. 26, 2014, the entire contents of which are incorporated herein by reference.

### FIELD

The embodiments discussed herein are related to a network control method, a communication apparatus and a communication system.

### BACKGROUND

There are various radio communication standards for communication between terminals over a wireless network. A radio communication standard is also called Radio Access Technology (RAT).

One example of the radio communication standards is a third generation radio communication standard (called “3G”) standardized as “Third Generation Partnership Project (3GPP).” An example of 3G may include Wideband Code Division Multiple Access (W-CDMA).

A 3G (e.g., W-CDMA) network includes a radio network and a core network. The radio network includes communication equipment such as base stations and a base station controller. A base station is also called “BTS” or “NodeB.” A base station controller is also called Radio Network Controller (RNC). RNC is connected to SGSN (Serving General packet radio service Support Node) which is an upper level device placed on the core network. A radio terminal (also called User Equipment (UE)) compatible with 3G may perform location registration and establish a call by sending a setup request to SGSN via the radio network (NodeB and RNC).

Examples of radio communication standards other than 3G may include Long Term Evolution (LTE) which is one of post-3G radio communication standards, and LTE-A (LTE-Advanced) which is a revised version of LTE. LTE may be said to belong to the 3.9^{th} generation and LTE-A may be said to belong to the fourth generation. Hereinafter, LTE and LTE-A will be collectively referred to as “LTE.”

An LTE network also includes a radio network and a core network. A base station (called “eNodeB (eNB)”) is placed on the LTE radio network and there exists no device corresponding to RNC of 3G in the LTE radio network. The base station (eNodeB) is connected to MME (Mobility Management Entity) which is an upper level device placed on the core network. The LTE UE may perform a location registration and establish a call by sending a setup request to the MME via the radio network (eNodeB).

A related technique is disclosed in, for example, Japanese Laid-Open Patent Publication No. 2004-320702.

### SUMMARY

According to an aspect of the invention, a network control method of a communication system into which a first node supporting a first radio communication standard in a first network, a second node supporting a second radio communication standard in a second network, the second node connecting with the first node, and a communication apparatus connected with the first node via a link are formed, the network control method includes: transmitting a first control signal bound for the first node, associated with a first terminal supporting the first radio communication standard, to the first node via the link; generating a second control signal bound for the first node, the second control signal including a third control signal bound for the second node, associated with a second terminal supporting the second radio communication standard, and a fourth control signal having a transmission instruction for transmitting the third control signal to the second node; and transmitting the second control signal to the first node via the link, by the communication apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a configuration example of a network system according to a first embodiment;

FIG. 2 is a view illustrating a configuration example of a network system according to a second embodiment;

FIG. 3 is a view illustrating a hardware configuration example of C-BBU and RRH illustrated in FIG. 2;

FIG. 4 is a view schematically illustrating a configuration example of C-BBU illustrated in FIG. 3;

FIG. 5 is a view illustrating a configuration example of an RNC processing unit;

FIG. 6 is a view illustrating a configuration example of a signal converting unit;

FIG. 7 is a view illustrating comparison between C-plane of LTE and C-plane of 3G;

FIG. 8 is a view illustrating comparison between U-plane of LTE and U-plane of 3G;

FIG. 9 is a view illustrating a data structure example of a table of communication control data stored in a storage area;

FIG. 10 is a flow chart illustrating an example of uplink signal processing in a signal converting unit (CPU);

FIG. 11 is a flow chart illustrating an example of a downlink signal processing in the signal converting unit (CPU);

FIG. 12 is an explanatory view of a protocol conversion;

FIG. 13 is a view illustrating one example of parameters (information) set in an S1AP layer for a control signal of a setup request (UE INITIAL CONTEXT SETUP) bound for MME;

FIG. 14 illustrates a format of a GTP-C protocol;

FIG. 15 is a view illustrating a hardware configuration example of a radio terminal (UE);

FIG. 16 is a sequence diagram illustrating an example of a setup sequence of 3G over an LTE call (LTE pseudo call) for a 3G UE; and

FIG. 17 is a sequence diagram illustrating an example of a procedure where a UE supporting both of 3G and LTE hands over from LTE to 3G.

### DESCRIPTION OF EMBODIMENTS

In order to create environments including both of a 3G radio network and an LTE radio network, it is contemplated to provide a communication apparatus having an integration of functions of the NodeB and the RNC function with functions of the eNodeB.

However, 3G and LTE have different configurations and communication protocols of communication equipment forming a network depending on a difference between radio communication standards of 3G and LTE. For example, a control signal of a setup request output from RNC of 3G may not be received in MME of LTE. Therefore, it is needful for the above-described communication apparatus to connect with the LTE core network (MME) via a link, while to connect with the 3G core network (SGSN) via a separate link.

This need is not limited to the relationship between 3G and LTE but is common to cases where a communication apparatus compatible with a plurality of radio communication standards is installed in any areas.

Hereinafter, embodiments of a technique capable of reducing the number of links for transmitting data to a node supporting both a first radio communication standard and a second radio communication standard will be described with reference to the accompanying drawings. The disclosed embodiments are illustrative only without any limitation.

### First Embodiment

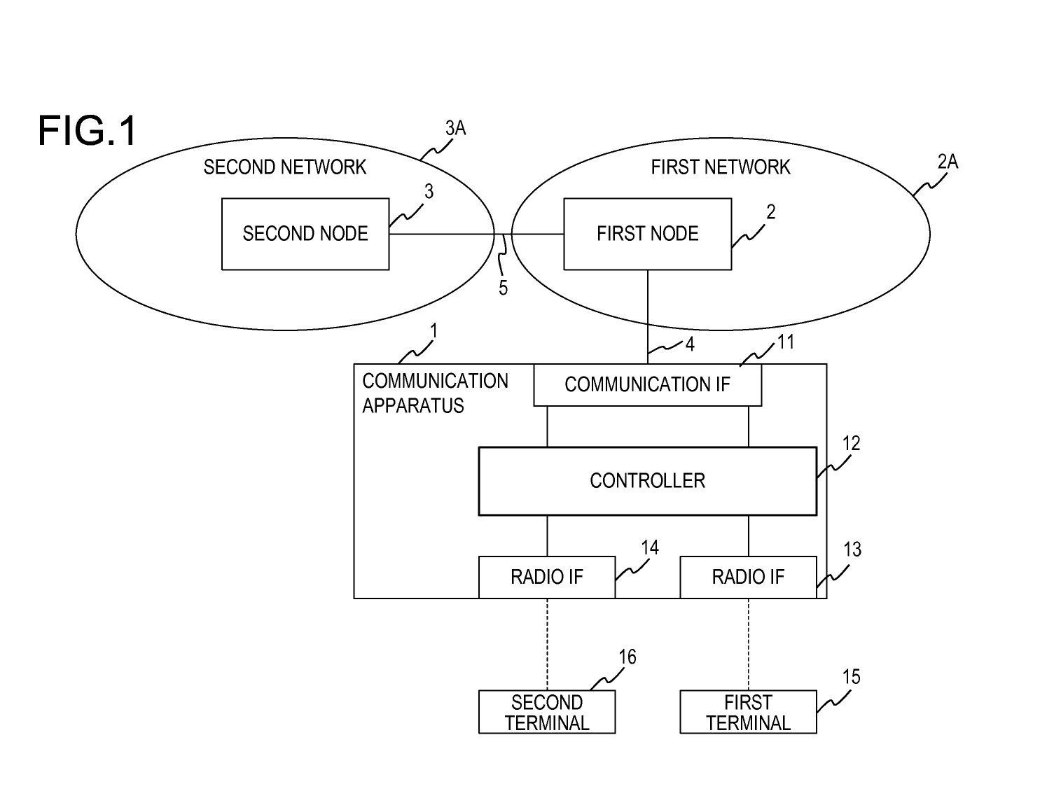

FIG. 1 is a view illustrating a configuration example of a network system according to a first embodiment. Referring to FIG. 1, a network system includes a communication apparatus 1, a first node 2 for supporting a first radio communication standard (first RAT), and a second node 3 for supporting a second radio communication standard (second RAT) different from the first RAT.

The first node 2 belongs to a first core network (one example of “first network”) 2A supporting the first RAT and the second node 3 belongs to a second core network (one example of “second network”) 3A supporting the second RAT.

The communication apparatus 1 is connected with the first node 2 via a link 4, and the first node 2 and the second node 3 are interconnected via a link 5. No link is established between the communication apparatus 1 and the second node 3.

The communication apparatus 1 has a communication interface (communication IF) 11 for connecting with the link 4 and transmitting and receiving data to/from the first node 2. In addition, the communication apparatus 1 includes a controller 12 having the radio network function of the first RAT and the radio network function of the second RAT.

The communication apparatus 1 further includes a radio interface (radio IF) 13 for connecting with a radio terminal (first terminal) 15 supporting the first RAT, and a radio IF 14 for connecting with a radio terminal (second terminal) 16 supporting the second RAT. A radio terminal is also called “UE” or “user.”

The controller 12 transmits a control signal (e.g., a control signal containing a setup request) received from a subordinate first terminal 15 which makes radio access, from the communication IF to the first node 2 via the link 4. Accordingly, the first network 2A performs processes and procedures for setup (or call establishment) of the first terminal.

In contrast, upon receiving a control signal (e.g., a control signal containing a setup request) from a subordinate second terminal 16 which makes radio access, the controller 12 generates a control signal containing a transmission instruction to transmit the control signal containing the setup request to the second node 3. The controller 12 transmits the generated control signal from the communication IF 11 to the first node 2 via the link 4.

The first node 2 transmits the control signal containing the setup request to the second node 3 according to the transmission instruction in the control signal received from the communication apparatus 1. Accordingly, the second network 3A performs processes and procedures for a setup (or a call establishment) of the second terminal 16. Accordingly, as illustrated in FIG. 1, a link between the communication apparatus 1 and the second node 3 may be reduced (eliminated).

Examples of the radio communication standards may include the 3.5 generation RAT such as High Speed Packet Access (HDPDA), the second generation RAT such as Global System for Mobile communication (GSM), and wireless LAN (Local Area Network) standards such as Wi-Fi and IEEE 802.11 standards. In the specification, “supporting a radio communication standard” means fitting or conforming to the radio communication standard.

For example, assuming that the first RAT is LTE and the second RAT is 3G (W-CDMA), the first node 2 is MME and the second node 3 is SGSN or xGSN. The controller of the communication apparatus 1 includes the function of eNodeB as the first RAT radio network function. In addition, the controller includes the function of NodeB and RNC as the second RAT radio network function.

The control signal bound for the second node 3 includes a control signal generated in the communication apparatus 1 and a control signal received from different communication equipment such an adjacent base station, in addition to the control signal received from the second terminal 16. Information contained in the control signal may include information used for a call establishment, information used for a maintenance and disconnection of call, and information on maintenance and monitoring of the communication apparatus 1, in addition to the above-mentioned setup request.

According to the first embodiment, a signal bound for the second node 3 can be transmitted to the second node 3 via the first node 2. This makes it possible to avoid establishing a link between the communication apparatus 1 and the second node 3. In other words, a link can be reduced.

### Second Embodiment

Next, as a second embodiment, one example of a network system including the communication apparatus described in the first embodiment will be described. The second embodiment illustrates an example in which the first RAT is LTE and the second RAT is 3G (W-CDMA).

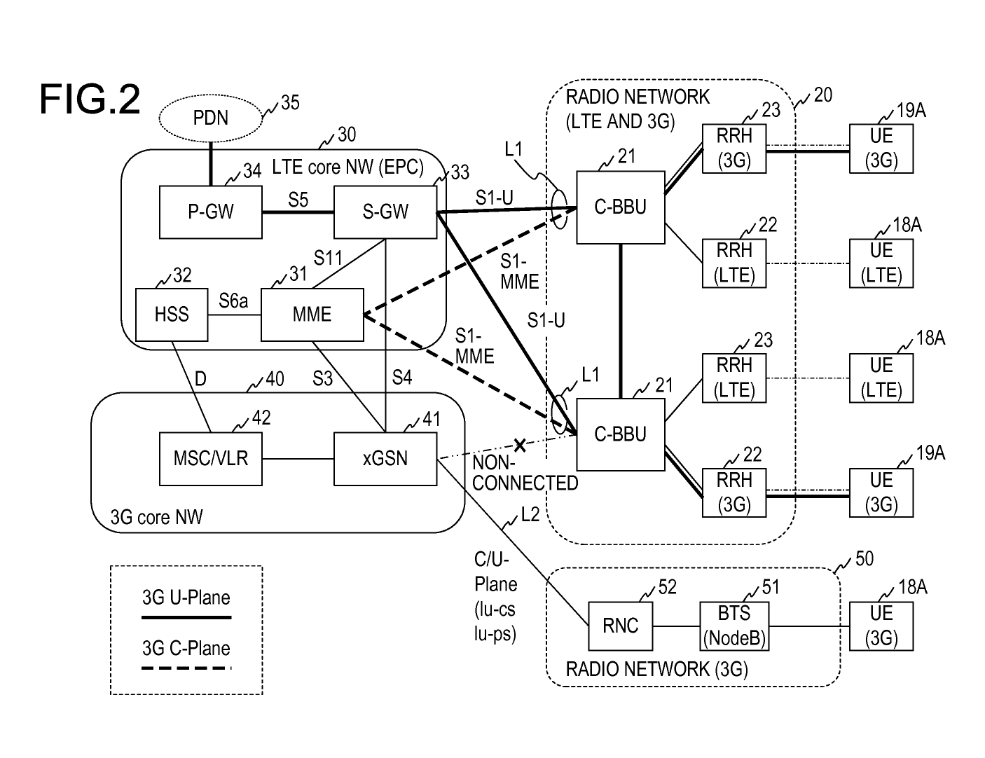

FIG. 2 is a view illustrating a configuration example of the network system according to the second embodiment. FIG. 2 illustrates a 3G (e.g., W-CDMA) network system and an LTE network system, as network systems. More specifically, a 3G and LTE radio network 20, an LTE core network 30, and a 3G core network 40 are illustrated. The core network 30 is connected to a 3G radio network 50.

The radio network 20 is an integration of a 3G radio network (called UMTS Terrestrial Radio Access Network (UTRAN)) and an LTE radio network (called enhanced UTRAN (eUTRAN)).

The radio network 20 includes RRH (Remote Radio Head) 22, RRH 23 and a C-BBU (Centralized-Based Band Unit) 21 having an integration of the 3G radio network function (NodeB and RNC function) and the LTE radio network function (eNodeB function).

FIG. 2 illustrates two C-BBUs 21. However, the radio network 20 may be formed of at least one C-BBU 21. Each C-BBU 21 is connected with the RRH 22 supporting 3G and the RRH 23 supporting LTE.

The RRH 22 is a radio processor for performing radio communication with a UE 18A supporting LTE. The RRH 23 is a radio processor for performing radio communication with a UE 19A supporting 3G. The RRH 22 and the RRH 23 are connected to the respective C-BBUs 21 via, for example, CPRI (Common Public Radio Interface). An interface between BBU and RRH is not limited to CPRI.

In the example of FIG. 2, each C-BBU 21 connects with one RRH 22 and one RRH 23. However, the number of RRHs 22 and RRHs 23 connected with the C-BBU 21 may be set appropriately.

The C-BBU 21 operates as NodeB for performing a digital base band process according to radio communication with the UE 19A, and RNC for performing a setup process of the UE 19A. In addition, the C-BBU 21 operates as eNodeB for performing a digital base band process according to radio communication with the UE 18A and a setup process of the UE 18A.

The C-BBU 21 is connected with the LTE core network 30 via a link L1. In contrast, no link is connected between the C-BBU 21 and the 3G core network 40. Therefore, the C-BBU 21 converts a signal bound for the core network 40 into a signal bound for the core network 30 and performs a signal converting process for transmitting a signal to the core network 40 via the core network 30.

The core network 30 is called EPC (Evolved Packet Core) or SAE (System Architecture Evolution). The core network 30 includes MME (Mobility Management Entity) 31, HSS (Home Subscriber Server) 32, a serving gateway (S-GW) 33 and a packet data network gateway (P-GW) 34. The P-GW 34 is connected with a packet data network (PDN) 35.

The MME 31 is a controller which connects with eNodeB and performs a mobility control of a radio terminal (UE). For example, based on a signal of control plane (C-plane) (control signal: also referred to as “message”), the MME 31 performs a management of location registration of UE in the HSS 32, call, and inter-base station handover. The MME 31 is connected with the C-BBU 21 via a S1-MME interface (an interface between MME-eNodeB) of S1 interfaces.

The HSS 32 is a device storing a subscriber information database and performs a management of authentication information and location information of UE. The HSS 32 is connected with the MME 31 via an S6a interface.

The S-GW 33 is connected with the MME 31 via an S11 interface. The S-GW 33 is a gateway device for controlling the transmission of a user packet (a packet of user plane (U-plane)) in the core network 30 under the control of the MME 31. The S-GW 33 is connected with the C-BBU 21 via an S1-U interface of S1 interfaces.

The P-GW 34 is connected with the S-GW 33 via an S5 interface. The P-GW 34 is a gateway device forming a junction with a PDN 35 and is responsible for an exchange of user packets between the S-GW 33 and the PDN 35. The PDN 35 is an external network connected with the core network 30.

The 3G core network 40 includes a serving/gateway General packet radio service Support Node (xGSN: 3G core network packet processing node) 41 and a Mobile Switching Center/Visited Location Register (MSC/VLR) 42.

The xGSN 41 is a device (communication device) which is an integration of SGSN (Serving General packet radio service Support Node) and GGSN (Gateway General packet radio service Support Node). The SGSN is a packet exchanger for performing a packet exchange and a packet communication, and provides, for example, the functions of UE mobility management. The GGSN is a junction with the PDN 35 and performs, for example, an IP address allocation, and a packet transmission to SGSN.

MSC is a logic node having a CS (Circuit Switched) function. The VLR is located between the UE and the HSS 32 and is a database which records and manages subscriber information. VLR provides, for example, the functions of user mobility management. The MSC/VLR 42 is a device (communication device) which is an integration of the MSC function and the VLR function.

The 3G radio network 50 includes a NodeB 51 for performing a radio communication with the UE 19A of 3G, and an RNC 52 connected with the NodeB 51. The RNC 52 is connected with the xGSN 41 via a link L2.

As described above, LTE is one example of “first radio communication standard” and 3G (W-CDMA) is one example of “first radio communication standard.” The C-BBU 21 is one example of a “communication apparatus.” The MME 31 is one example of a “first node.” The xGSN 41 (SGSN) is one example of a “second.” The LTE network (the core network 30 and the radio network) is one example of a “first network” and the 3G network (the core network 40 and the radio network) is one example of a “second network.”

Although the device having the 3G and LTE base station functions which are separated into BBU and RRH has been illustrated in FIG. 2, the device may be configured with BBU and RRH being integrated.

<Configuration Example of C-BBU>

<<Hardware Configuration>>

The C-BBU 21 is a device functioning as a control unit, a baseband unit and a transmission line interface unit. The control unit performs the overall control of a base station, protocol of call control and control monitoring. The transmission line interface unit connects a transmission line such as, for example, the Ethernet and processes a protocol such as, for example, IPsec, or IPv6 to perform an IP packet exchange. The baseband unit performs a conversion (modulation/demodulation) between an IP packet exchanged through the transmission line interface unit and a baseband signal transmitted wirelessly.

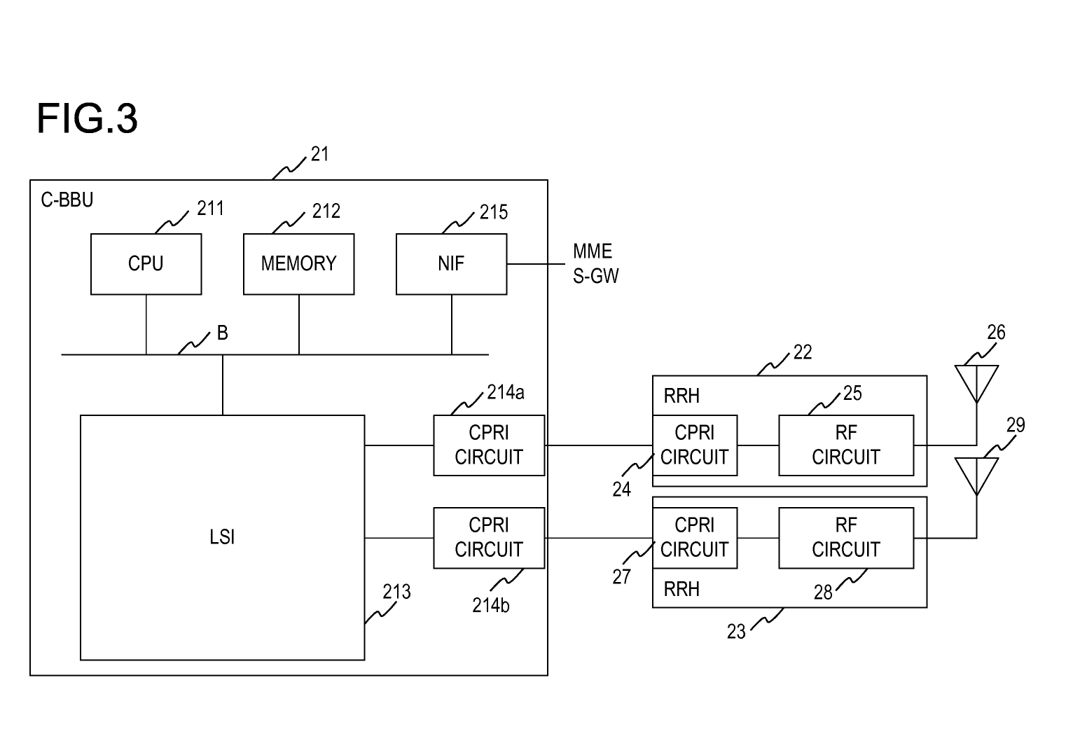

FIG. 3 is a view illustrating a hardware configuration example of the C-BBU 21, the RRH 22, and the RRH 23, illustrated in FIG. 2. Referring to FIG. 3, the C-BBU 21 includes a CPU (Central Processing Unit) 211, a memory 212, an LSI (Large Scale Integrated circuit) 213, CPRI circuits 214a and 214b, and a network interface (NIF) 215, which are interconnected via a bus B.

The memory 212 is one example of a “storage device” or a “computer-readable recording medium.” The memory 212 includes a main storage device and an auxiliary storage device. The main storage device is used as a work area of the CPU 211. The main storage device is formed of, for example, RAM (Random Access Memory) or a combination of RAM and ROM (Read Only Memory).

The auxiliary storage device is at least one selected from a group consisting of HDD (Hard Disk Drive), SSD (Solid State Drive), a flash memory and EPROM (Erasable Programmable Read Only Memory). The auxiliary storage device may include disk recording media such as, for example, CD, DVD, and Blu-ray.

The LSI 213 may be formed of at least one of, for example, a general-purpose LSI, ASIC (Application Specific Integrated Circuit) and a programmable logic device (PLD) such as FPGA (Field Programmable Gate Array). The LSI 213 may include DSP (Digital Signal Processor).

The LSI 213 is an integrated circuit operating as the above-described baseband processing unit. The LSI 213 performs the above-described conversion between the IP packet and the baseband signal for a user plane (U-plane) signal. In addition, the LSI 213 performs a process of passing over a control signal, which is obtained from a baseband signal received from UE or an IP packet received from a core network or another base station (adjacent base station). In the meantime, the LSI 213 performs a process of converting a control signal obtained from the CPU 211 into an IP packet bound for a core network or another base station or a baseband signal bound for UE.

The NIF 215 is an interface circuit or a device operating as the above-described interface unit. The NIF 215 connects with a transmission line (link L1) such as the Ethernet (LAN). The NIF 215 is connected with different communication devices such as, for example, the MME 31, the S-GW 33, and an adjacent base station and performs an exchange of IP packets with these communication devices. An example of the NIF 215 may include a LAN card or a network interface card.

The CPRI circuits 214a and 214b (referred to as a “CPRI circuit 214” if not distinguished between them) are interface circuits with RRH supporting CPRI. The CPRI circuit 214a is connected with the RRH 22 for LTE via an optical fiber or a metal cable, and the CPRI circuit 214b is connected with the RRH 23 for 3G via an optical fiber or a metal cable. The CPRI circuit 214 converts a baseband signal bound for the corresponding RRH into a signal having a CPRI-based signal format (referred to as a “CPRI signal”) which is then sent to the RRH. In addition, the CPRI circuit 214 returns a CPRI signal received from the corresponding RRH to the original baseband signal which is then input to the LSI 213.

The CPU 211 loads a program stored in the auxiliary storage device of the memory 212 into the main storage device and executes the program. Accordingly, the CPU 211 operates as the above-described control unit. The CPU 211 is one example of a “processor” or “controller.” The “processor” is intended to include a microprocessor (MPU) and DSP. In addition, the process executed by the CPU 211 may be executed by, for example, a hardware logic using an integrated circuit. For example, the process executed by the CPU 211 may be executed by the LSI 213.

The RRH 22 is a device functioning as a radio unit of eNodeB. The RRH 22 includes a CPRI circuit 24, an RF circuit 25 and an antenna 26. The CPRI circuit 24 returns a CPRI signal received from the CPRI circuit 214a to a baseband signal which is then sent to the RF circuit 25. In addition, the CPRI circuit 24 converts a baseband signal from the RF circuit 25 into a CPRI signal which is then sent to the CPRI circuit 214a.

The RF circuit 25 includes, for example, a modulation/demodulation circuit, an up-converter, a power amplifier (PA), a duplexer, a low noise amplifier (LNA) and a down-converter. The duplexer is connected to the antenna 26 which is a transceiver antenna.

The modulation/demodulation circuit modulates a baseband signal from the CPRI circuit 24 into an analog signal or converts an analog signal from the down-converter into a baseband signal which is then sent to the CPRI circuit 24. The up-converter up-converts the analog signal modulated in the modulation/demodulation circuit into a predetermined radio frequency (RF) signal. The PA amplifies the up-converted signal. The amplified signal is radiated as an electromagnetic wave from the antenna 26 via the duplexer.

The antenna 26 receives a radio signal from the subordinate UE 18A. The duplexer connects the radio signal to the LNA. The LNA amplifies the radio signal with low noise. The down-converter down-converts the low noise-amplified signal into an analog signal. The modulation/demodulation circuit converts the analog signal into a baseband signal by demodulation of the analog signal and sends the baseband signal to the CPRI circuit 24.

The RRH 23 is a device functioning as a radio unit of 3G base station (NodeB). The RRH 23 includes a CPRI circuit 27, an RF circuit 28, and an antenna 29. The CPRI circuit 27 returns a CPRI signal received from the CPRI circuit 214b to a baseband signal which is then sent to the RF circuit 28. In addition, the CPRI circuit 27 converts a baseband signal from the RF circuit 28 into a CPRI signal which is then sent to the CPRI circuit 214b.

The RF circuit 28 includes, for example, a modulation/demodulation circuit performing the same operation as the RF circuit 25, an up-converter, a power amplifier (PA), a duplexer, a low noise amplifier (LNA), and a down-converter. The RF circuit 28 is connected with the antenna 29 which is a transceiver antenna. The antenna 29 performs a radio communication (transmitting and receiving electromagnetic wave) with the subordinate UE 19A.

The NIF 215 can be used as the communication IF 11 of the first embodiment. The CPU 211 and the LSI 213 can be used as the controller 12 of the first embodiment. The RF circuit 25 and the antenna 26 can be used as the radio IF 13 of the first embodiment, and the RF circuit 28 and the antenna 29 can be used as the radio IF 14.

<<Functional Configuration of C-BBU>>

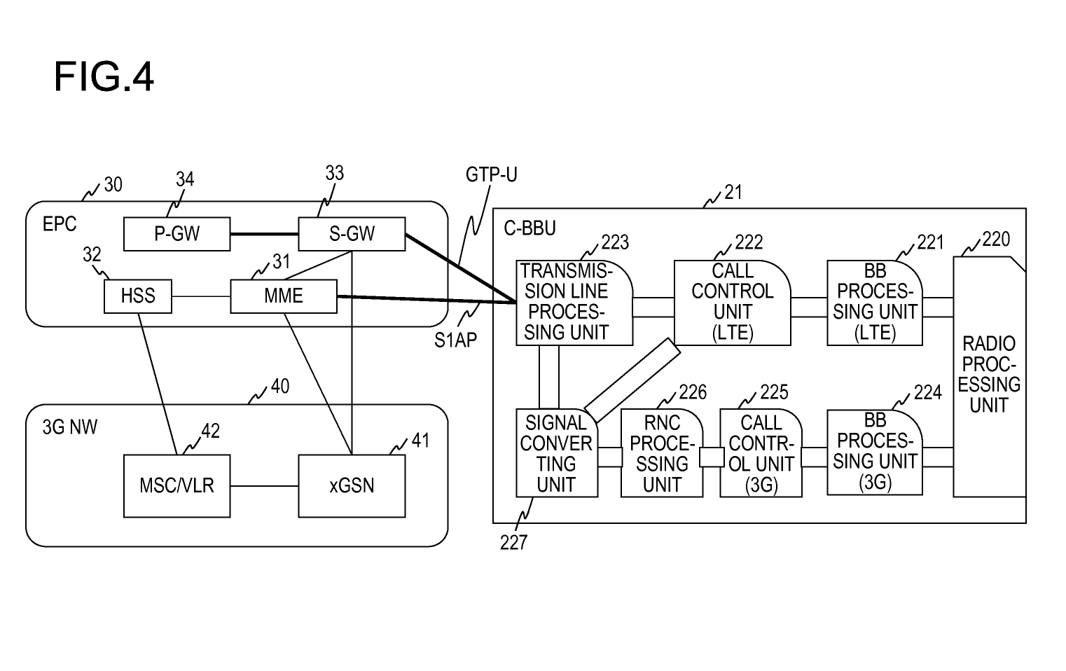

FIG. 4 is a view schematically illustrating a configuration example of the C-BBU 21 illustrated in FIG. 3. Referring to FIG. 3, the C-BBU 21 includes a radio processing unit 220. The C-BBU 21 further includes a baseband (BB) processing unit (LTE) 221, a call control unit (LTE) 222, and a transmission line processing unit 223, all of which are elements corresponding to eNodeB (LTE radio network).

In the meantime, the C-BBU 21 includes a BB processing unit (3G) 224, a call control unit (3G) 225, and an RNC processing unit (3G) 226, all of which are elements corresponding to a 3G radio network (NodeB and RNC). The C-BBU 21 also includes a signal converting unit 227 as a common element between LTE and 3G.

The radio processing unit 220 corresponds to the function of the RRH 22 and CPRI circuit 214a, and the function of the RRH 23 and CPRI circuit 214b, illustrated in FIG. 3. The radio processing unit 220 performs an exchange of LTE-based baseband signal with the BBU 221 and an exchange of 3G-based baseband signal with the BBU 224.

The BB processing unit 221 and the BB processing unit 224 correspond to the function of LSI 213 illustrated in FIG. 3. The BB processing unit 221 performs a baseband process according to the LTE baseband signal, and the BB processing unit 224 performs a baseband process according to the 3G baseband signal.

The call control unit 222, the call control unit 225, the RNC processing unit 226, and the signal converting unit 227 are the functions achieved by the CPU 211 that executes a program. The call control unit 222 performs a call control such as, for example, a setup, and a disconnection related to the LTE UE 18A. The call control unit 225 performs a call control such as, for example, a setup, and a disconnection related to the 3G UE 19A. The transmission line processing unit 223 corresponds to the function of NIF 215.

[RNC Processing Unit]

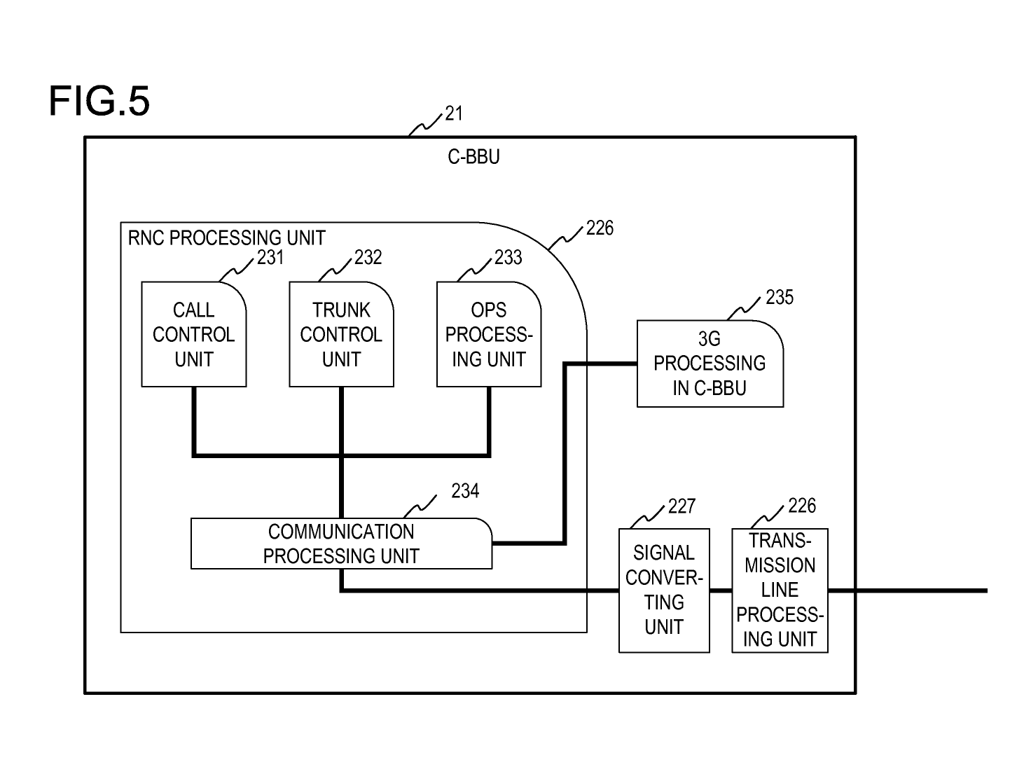

The RNC processing unit 226 performs an operation as the 3G RNC. FIG. 5 is a view illustrating a configuration example of the RNC processing unit 226. The RNC processing unit 226 includes a call control unit 231, a trunk processing unit 232, an OPS processing unit 233, and a communication processing unit 234.

The call control unit 231 terminates an RRC (Radio Resource Control) protocol and an RLC (Radio Link Control) protocol with the UE 18A. The RRC performs a call control reception and a handover control. The RLC performs a management of radio resources, and a demultiplexing and retransmission of transmitting and receiving signals. In addition, the call control unit 231 terminates a call control signal with, for example, a different base station (NodeB), a different RNC, and the xGSN 41.

The trunk processing unit 232 performs a termination of signals according to various 3Gs. For example, the trunk processing unit 232 performs a signal processing of transmitting and receiving data of a common channel and individual channels, a termination of radio data links, and a frame processing of an HSDPA channel.

The OPS processing unit 233 terminates an interface with OPS (Operation System) which is a monitor connected with the C-BBU 21 via a network and performs a monitoring control of the overall process 235 related to 3G of the C-BBU 21. The communication processing unit 234 performs a communication with a different processing unit.

[Signal Converting Unit]

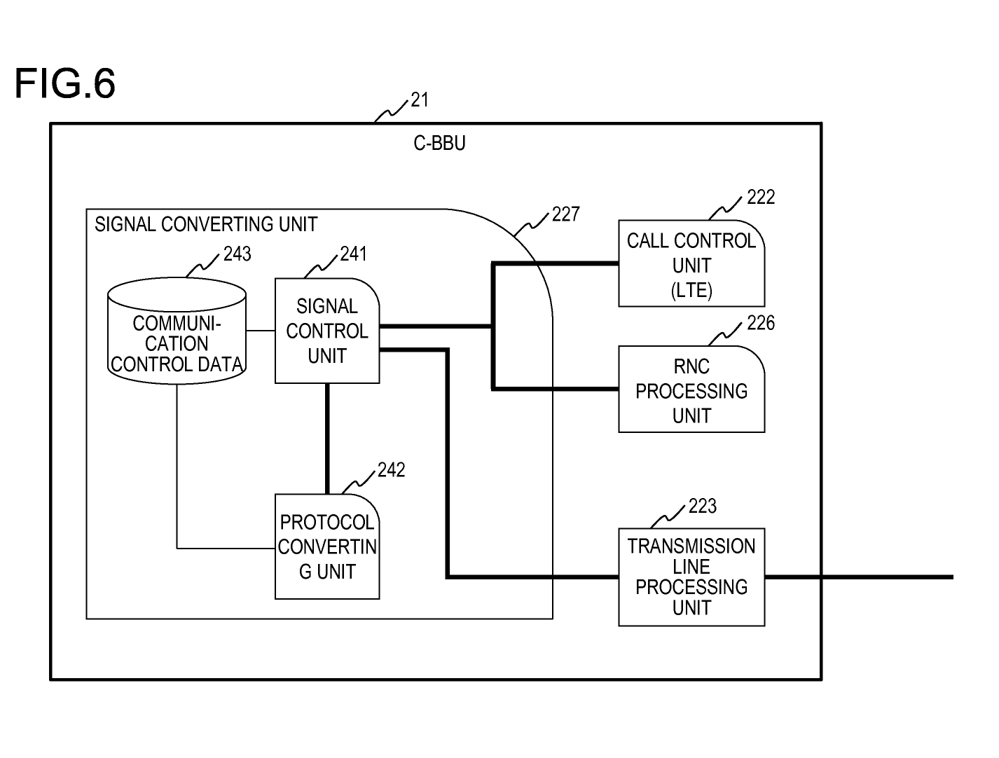

FIG. 6 is a view illustrating a configuration example of the signal converting unit 227. Referring to FIG. 6, the signal converting unit 227 includes a signal control unit 241, a protocol converting unit 242, and a storage area 243 of communication control data. The storage area 243 is formed on the memory 212.

The C-BBU 21 handles a C-plane signal and a U-plane signal according to 3G and LTE. In this specification, the C-plane signal is referred to as a “control signal” and the U-plane signal is referred to as a “signal other than control signal,” “user data,” or “user packet.”

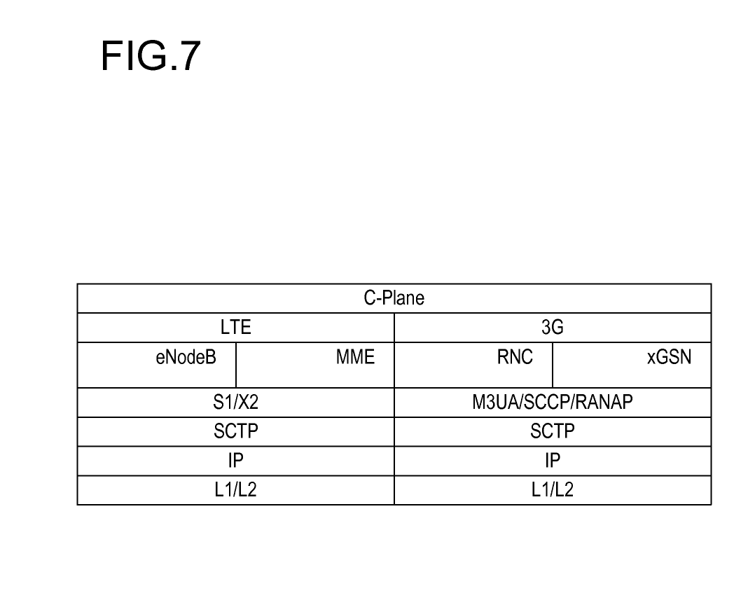

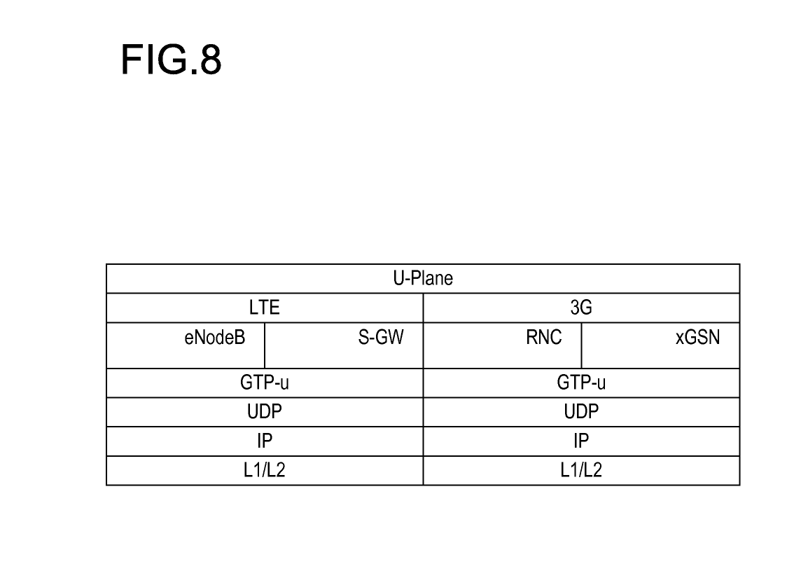

FIG. 7 is a view illustrating a comparison between C-plane of LTE and C-plane of 3G, and FIG. 8 is a view illustrating a comparison between U-plane of LTE and U-plane of 3G. As illustrated in FIG. 7, LTE and 3G have compatibility for a SCTP (Stream Control Transmission Protocol) layer or below. However, LTE and 3G have no compatibility for a S1/X2 layer and an M3UA/SCCP/RANAP layer. In the meantime, as illustrated in FIG. 8, in the U-plane, LTE and 3G have a GTP-U layer or below in common.

Returning to FIG. 6, the signal control unit 241 receives the C-plane and U-plane signals, and determines a transmission destination thereof. For example, the signal control unit 241 determines a transmission destination node of a signal received from the RNC processing unit 226 by referring to the communication control data. In addition, the signal control unit 241 can obtain information indicating a load situation in the C-BBU 21 and a load situation of a transmission line to other nodes, store the information in the storage area 243, and determine a signal communication path based on the stored information. In addition, the signal control unit 241 determines whether or not protocol conversion is required depending on a signal transmission destination, and instructs the protocol converting unit 242 to perform the protocol if necessary.

[[Communication Control Data]]

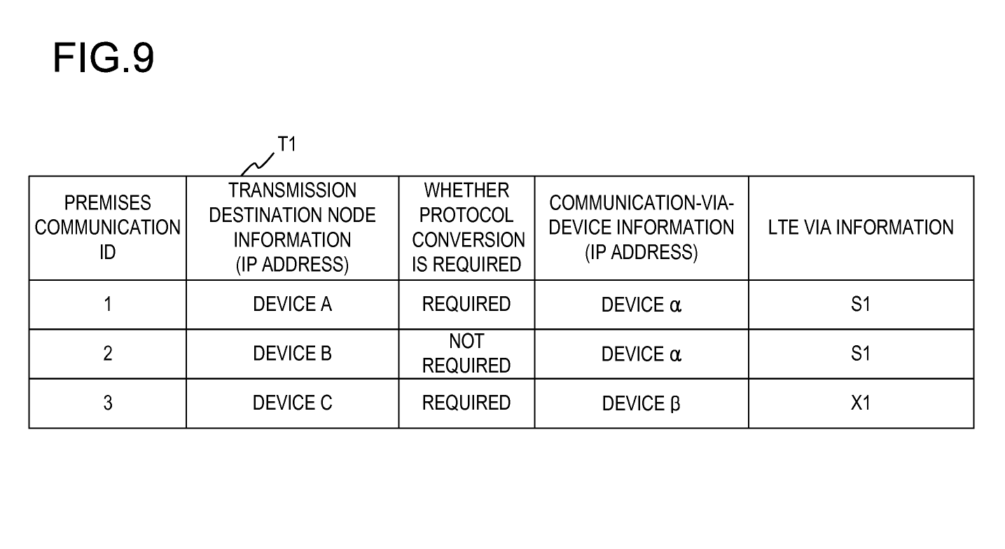

FIG. 9 is a view illustrating a data structure example of a table T1 of the communication control data stored in the storage area 243. Referring to FIG. 9, the table T1 may include premises communication ID, transmission destination node information (IP address) corresponding to the premises communication ID, information regarding whether protocol conversion is required, communication-via-device information (IP address), and LTE-via-information.

The premises communication ID is an ID for internal communication in the C-BBU 21. The transmission destination node information indicates a signal reception destination node. For example, if a signal is bound for the xGSN 41, an IP address of the xGSN 41 is stored as the transmission destination node information. If a signal is bound for the MME 31, an IP address of the MME 31 is stored as the transmission destination node information. If a signal is bound for an adjacent base station, an IP address of the base station is stored.

The information regarding whether protocol conversion is required is information indicating whether or not a protocol conversion between 3G and LTE (a conversion of signal format based on the communication protocol) is required. For example, if protocol conversion is required, information indicating “required” is set. If protocol conversion is not required, information indicating “not required” is set. For example, the information on whether or not a protocol conversion is required is set with a flag indicating one of “required” and “not required.” However, information related to only one of “required” and “not required” may be set.

The communication-via-device information is information indicating a device (via node) through which a communication to the transmission destination node goes and is stored with, for example, an IP address of the corresponding node. For example, for a signal bound for the xGSN 41, an IP address of the MME 31 is stored as the via node information.

The LTE-via-information is stored with identification information of an interface transmitting a signal. For example, for a signal bound for the MME 31 (the core network 40), identification information of an S1 interface is stored as the interface information. For a signal bound for an adjacent base station, identification information of an X2 interface is stored as the interface information.

Information registered as the transmission destination node information or the communication-via-device information may be identification information (identifier) of a device or a node. In this case, a correspondence table of identification information and IP address is separately set and the IP address is calculated from the identification information.

[Uplink Signal Processing]

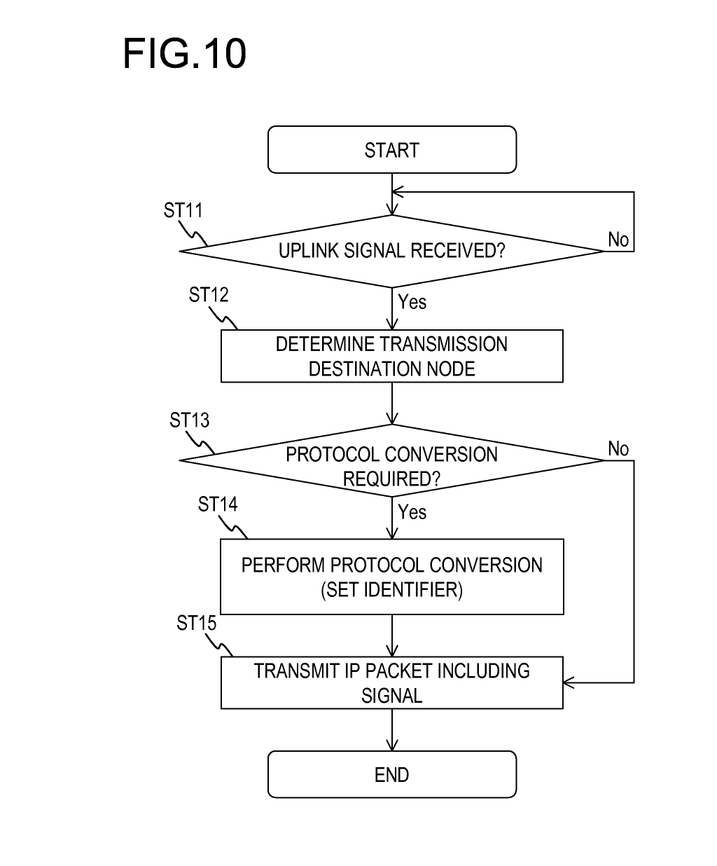

FIG. 10 is a flow chart illustrating an example of uplink signal processing in the signal converting unit 227. The processing illustrated in the flow chart is achieved by the CPU 211 operating as the signal converting unit 227 to execute a program.

At initial ST11, the signal control unit 241 of the signal converting unit 227 waits an uplink signal from the RNC processing unit 226 or the call control unit 222. The uplink signal includes a signal exchanged with a base station (X2 interface signal), in addition to a signal directed from a radio network to a core network.

Upon receiving the uplink signal, the signal control unit 241 searches an entry corresponding to a premises communication ID included in the signal from the table T1 in the storage area 243 by referring to the table T1, and specifies a node having the transmission destination node information in the entry as a transmission destination node (ST12).

Subsequently, the signal control unit 241 determines whether or not to perform a protocol conversion for the signal by referring to information (flag) in the searched entry on whether or not protocol conversion is required (ST13). If it is determined that the protocol conversion is not required (No at ST13), the process proceeds to ST14. The indication that the protocol conversion is not required means that the uplink signal is an LTE signal, and the indication that the protocol conversion is required means that the uplink signal is a 3G signal.

At ST14, the signal control unit 241 instructs the protocol converting unit 242 to perform the protocol conversion. According to this instruction, the protocol converting unit 242 performs the protocol conversion (3G→LTE) for the uplink signal. Details of the protocol conversion will be described later.

At ST15, the signal control unit 241 performs a process of generating and transmitting an IP packet including the signal. That is, the signal control unit 241 generates an IP packet including the signal (a signal which does not require the protocol conversion and a protocol-converted signal) and transmits the IP packet to the transmission line processing unit 223. At this time, the signal control unit 241 sets an IP address, as the communication-via-device information in the searched entry, in a reception destination address of the IP packet. The transmission line processing unit 223 transmits the IP packet. The IP packet is received in a communication-via-device (e.g., the MME 31).

[Downlink Signal Processing]

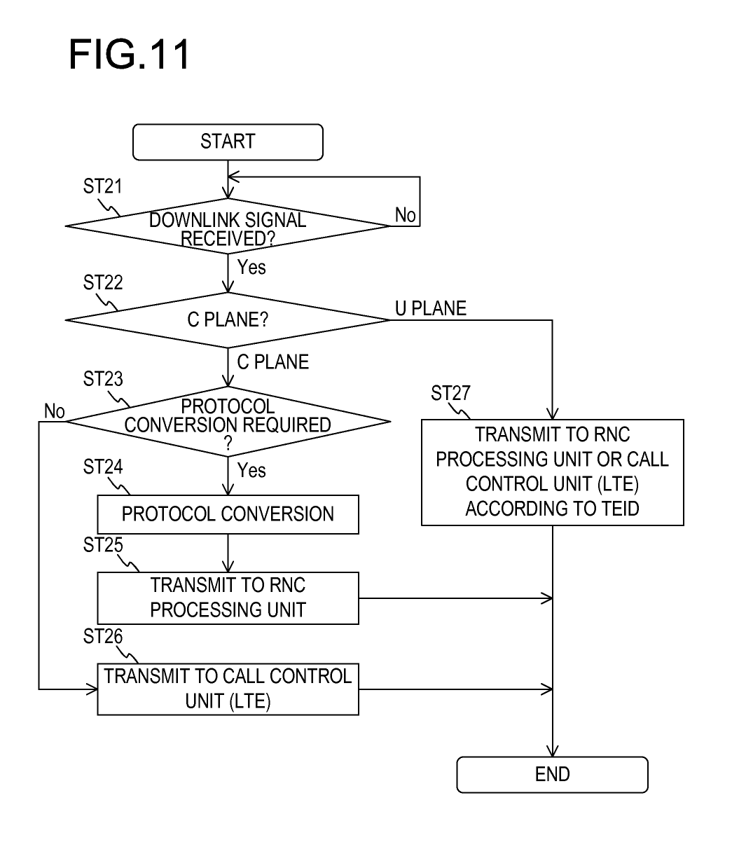

FIG. 11 is a flow chart illustrating an example of a downlink signal processing in the signal converting unit 227. The processing illustrated in the flow chart is achieved by the CPU 211 operating as the signal converting unit 227 to execute a program.

At the initial ST21, the signal control unit 241 of the signal converting unit 227 waits for a downlink side (core network→radio network) signal (e.g., a down link signal). Upon receiving the downlink signal, the signal control unit 241 determines whether or not the downlink signal is a C-plane signal (ST22). For example, the signal control unit 241 can determine whether the downlink signal is a control signal or user data by analyzing the format of the signal (see, e.g., FIGS. 7 and 8). If it is determined that the signal is a C-plane signal, the process proceeds to ST23. If it is determined that the signal is a U-plane signal, the process proceeds to ST27.

At ST23, the signal control unit 241 determines whether or not a protocol conversion for the signal is required. This determination is made, for example, depending on whether or not a signal reception destination (e.g., a reception destination IP address) is the RNC processing unit 226 (RNC) (or the signal reception destination is the call control unit 222 (eNodeB) in the analysis made in ST22. If the reception destination IP address is an IP address of the RNC processing unit 226, it is determined that the protocol conversion is required. Otherwise (or if the reception destination IP address is an IP address of the call control unit 222), it is determined that the protocol conversion is not required. If the protocol conversion is required (Yes at ST23), the process proceeds to ST24. Otherwise (No at ST23), the process proceeds to ST26.

At ST24, the signal control unit 241 transmits an instruction to the protocol converting unit 242 which then performs a protocol conversion (LTE→3G) for the signal according to this instruction. When the protocol conversion is terminated, the signal control unit 241 sends a signal obtained by the conversion to the RNC processing unit 226.

At ST26, the signal control unit 241 sends the signal to the call control unit 222. Thus, the signal control unit 241 can distribute the LTE downlink signal to the call control unit 222, while distributing the 3G downlink signal to the RNC control unit 226 after subjecting this signal to the protocol conversion.

At ST27, the signal control unit 241 distributes user data to the call control unit 222 and the RNC processing unit 226. For example, the signal control unit 241 can distribute user data according to TEID (Tunnel Endpoint Identifier) included in the user data.

The TEID is an identifier of a tunnel (GTP-U (GPRS (General Packet Radio Service) Tunneling Protocol for User Plane) path) for transmission of user data related to each of the LTE UE 18A and the 3G UE 19A. A correspondence table (not illustrated) associating the TEID with a distribution destination is stored in the storage area 243 (the memory 212). The signal control unit 241 may recognize the transmission destination of the downlink signal by obtaining information of the distribution destination corresponding to the TEID of the downlink signal from the correspondence table. The signal control unit 241 transmits the downlink signal to one of the RNC processing unit 226 and the call control unit 222 according to the information indicating the distribution.

[Protocol Conversion]

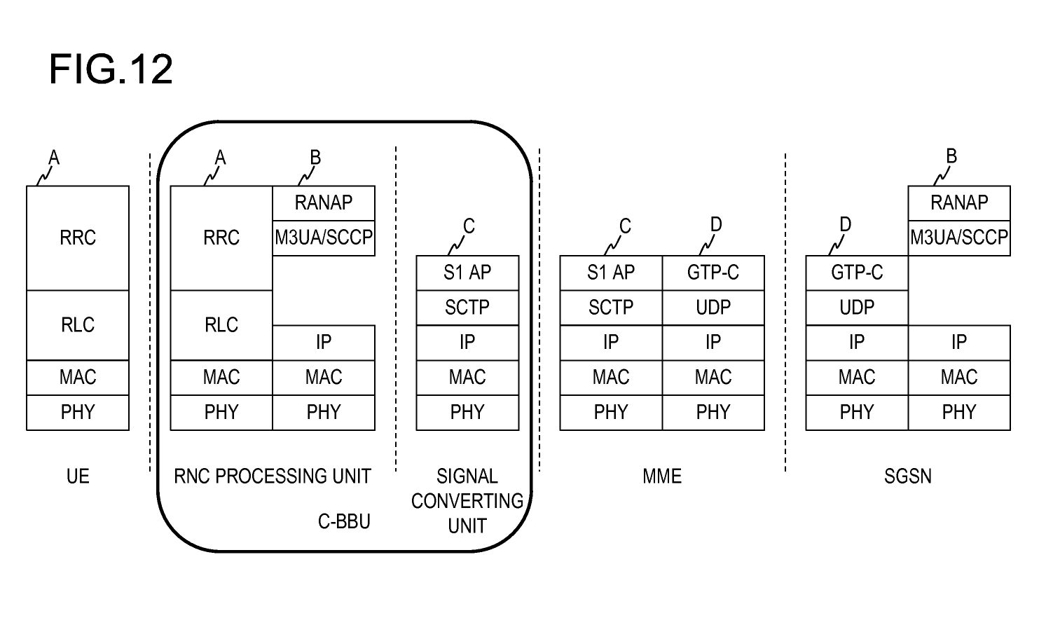

Next, the protocol conversion will be described according to a 3G call (referred to as a “3G over LTE call” or “LTE pseudo call”) via an LTE network, which includes the protocol conversion by the protocol converting unit 242. FIG. 12 is an explanatory view of a protocol conversion, illustrating one example of a change in the protocol stack of a C-plane signal (control signal) when 3G over LTE is performed.

The RNC processing unit 226 sets a connection of RRC and RLC by a radio connection with the 3G UE 19A. A protocol stack A of a control signal transmitted from the UE 19A includes a PHY layer, an MAC (Media Access Control) layer, an RLC layer, and an RRC layer.

The RNC processing unit 226 receives a control signal containing a message of a setup request from the UE 19A. The setup request is a message indicating that the UE 19A wirelessly connected with the C-BBU 21 requests a call establishment via the C-BBU 21.

The RNC processing unit 226 terminates RNC and RRC of the control signal and converts the protocol stack of the control signal into a protocol stack B including a PHY layer, an MAC layer, an IP layer, an M3UA/SCCP layer, and a RANAP layer. In some cases, the protocol stack B may include a STCP layer.

The RNC processing unit 226 supplies the control signal (the protocol stack B) to the signal converting unit 227. Upon receiving the control signal, the signal converting unit 227 performs a process for the uplink signal (FIG. 10). At this time, protocol conversion (the step of ST14 in FIG. 10) is performed by the protocol converting unit 242 of the signal converting unit 227.

The protocol converting unit 242 converts the control signal having a signal format compatible with the protocol stack B into a protocol stack C including a PHY layer, an MAC layer, an IP layer, a SCTP layer, and a S1AP layer for performance of 3G over LTE.

The MME 31 performs an operation by analyzing information of the S1AP layer in the control signal. Therefore, if no S1AP layer exists in the received control signal, the MME 31 cannot handle the control signal. By adding the S1AP layer by the protocol conversion, the control signal has a signal format which can be analyzed by the MME 31. In the protocol stack C of FIG. 12, an M3UA/SSCP layer and an RANAP layer are not illustrated, and information of these layers is included in the control signal after the conversion by the signal converting unit 227.

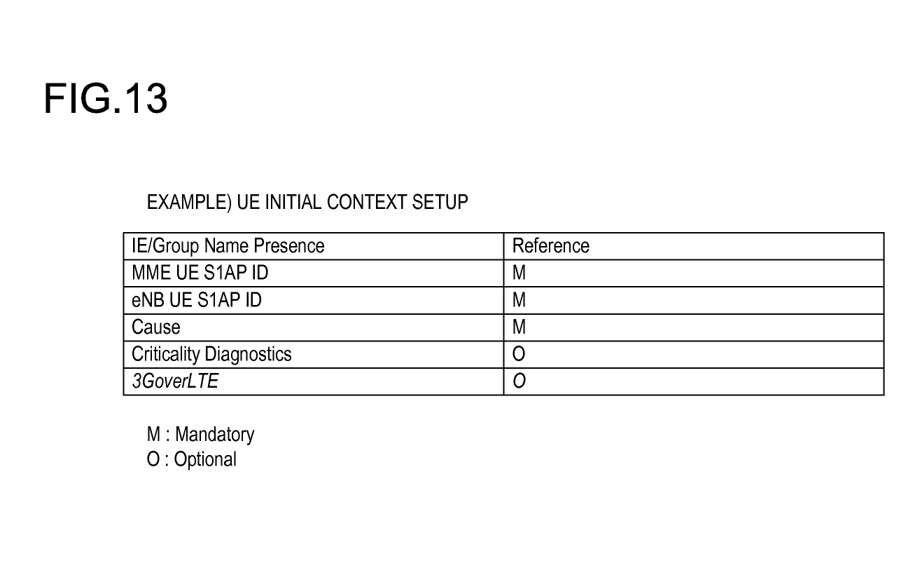

FIG. 13 is a view illustrating one example of parameters (information) set in the S1AP layer for a control signal of a setup request (UE INITIAL CONTEXT SETUP) bound for the MME 31. In FIG. 13, for example, “MME UE S1AP ID” is identification information uniquely identifying UE on a S1 interface in the MME and “eNB UE S1AP ID” is identification information uniquely identifying UE on the S1 interface in a base station.

When 3G over LTE is performed, i.e., when the protocol conversion is performed by the protocol converting unit 242, the protocol converting unit 242 includes an identifier (identification information) of “3G over LTE” in the S1AP layer of the control signal. This identifier means transmitting the message (control signal) of the setup request from the MME 31 to the xGSN 41. In other words, the corresponding identification information is analyzed as an instruction (transmission instruction) for the MME 31 to transmit the setup request to the xGSN 41. Thus, the protocol converting unit 242 generates the control signal (protocol stack B) bound for the xGSN 41 and the control signal (protocol stack C) including the transmission instruction (the identifier of “3G over LTE”) to the xGSN 41.

For the IP layer of the control signal of the protocol stack C, an IP address of a transmission destination node obtained from the table T1 by the signal control unit 241 is set as a reception destination address. The signal control unit 241 generates an IP packet including a control signal having a signal format of protocol stack C, sets an IP address of a communication-via-device in the reception destination address of the IP packet (encapsulates the control signal in an IP header), and sends the IP packet to the transmission line processing unit 223 (the NIF 215) (ST15 in FIG. 10). The IP packet is transmitted from the transmission line processing unit 223 and is received in the MME 31.

Upon determining that the reception destination address of the IP packet received from the C-BBU 21 is addressed (i.e., sent) to its own device, the MME 31 performs a process for the control signal (protocol stack C) in the IP packet. The MME 31 analyzes the S1AP layer in the control signal. At this time, if the MME 31 determines that the control signal is a setup request and contains the identifier of “3G over LTE,” the MME 31 transmits the control signal to the xGSN 41 (including SGSN). In addition, the MME 31 sends an IP packet including a control signal (protocol stack D) to the xGSN 41 whose IP address has already been known to the MME 31.

In the transmission, the MME 31 converts a signal format of the control signal into the protocol stack D on an S3 interface between MME and xGSN, and sends the protocol stack D to the xGSN 41. At this time, the MME 31 includes the identifier of “3G over LTE” in a GTP-C layer of the control signal (protocol stack D).

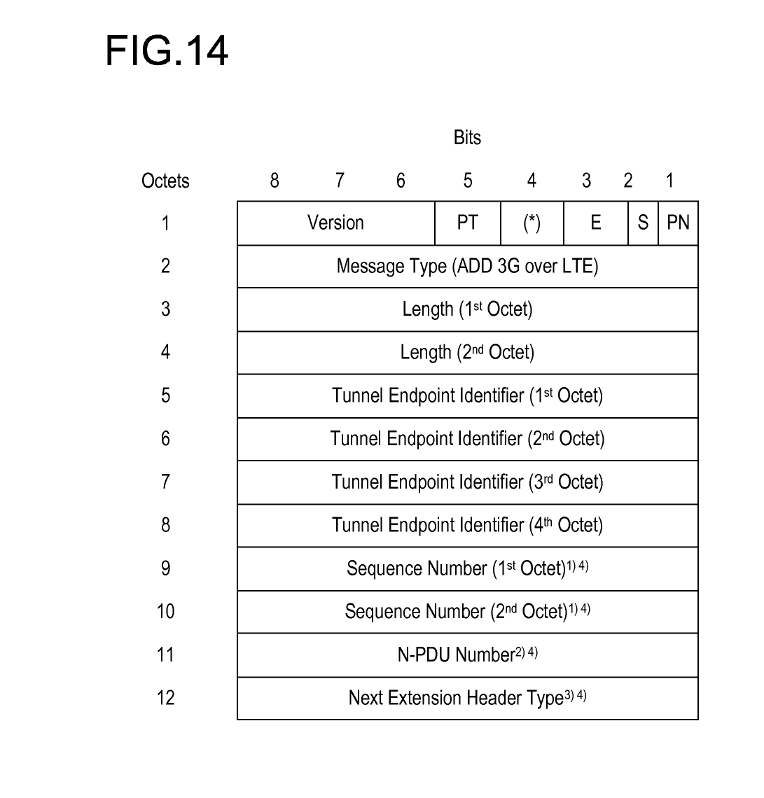

FIG. 14 illustrates a format of GTP-C protocol. The identifier of “3G over LTE” is set in a field of “Message Type” which is one of fields forming the format.

Upon receiving the control signal (protocol stack D) from the MME 31, the xGSN 41 (SGSN) recognizes the control signal as information of a “3G over LTE” call, based on the message type (the identifier of “3G over LTE”) of the GTP-C layer. The xGSN 41 restores the signal format of control signal to the original protocol stack B. This provides a state in which the setup request of 3G call generated in the RNC processing unit 226 is received in the SGSN. The xGSN 41 terminates the 3G protocol (RANAP and M3UA/SCCP).

The xGSN 41 stores the information of the “3G over LTE” call (connection information). The connection information includes, for example, identification information of at least one of RNC and UE 19A. When the xGSN 41 generates a control signal bound for RNC or UE, the connection information is used to determine whether or not the control signal is transmitted via the MME 31.

The xGSN 41 performs an authentication concealment procedure of the UE 19A based on the setup request. At this time, the xGSN 41 generates a downlink signal (protocol stack B) bound for the UE 19A. The xGSN 41 uses the stored connection information to determine whether or not the control signal is sent via the MME 31.

For example, if the identification information of the UE 19A in the downlink signal matches the connection information, the xGSN 41 converts the downlink signal into a signal format (protocol stack D) bound for the MME 31 and sets the identifier of “3G over LTE” in the message type of the GTP-C layer.

Upon receiving the downlink signal from the xGSN 41, the MME 31 converts the signal format of downlink signal into the protocol stack C. In this conversion, the identifier of “3G over LTE” set in the GTP-C layer is included in the S1AP layer. The MME 31 transmits the downlink signal to the C-BBU 21 by referring to a reception destination of the downlink signal.

In the C-BBU 21, the downlink signal is received in the transmission line processing unit 223 (NIF 215) and is provided to the signal converting unit 227 (CPU 211). The signal converting unit 227 performs a process for the downlink signal (FIG. 11). Accordingly, the signal format of downlink signal is converted into the protocol stack B which is then provided to the RNC processing unit 226. The downlink signal is converted into a signal format of protocol stack A in the RNC processing unit 226, which is then transmitted to the UE 19A.

Thereafter, for a C-plane signal (control signal) transmitted from the UE 19A to the xGSN 41, the same protocol conversion as described above is performed and the converted C-plane signal is sent to the xGSN 41 via the MME 31.

<Configuration Example of UE>

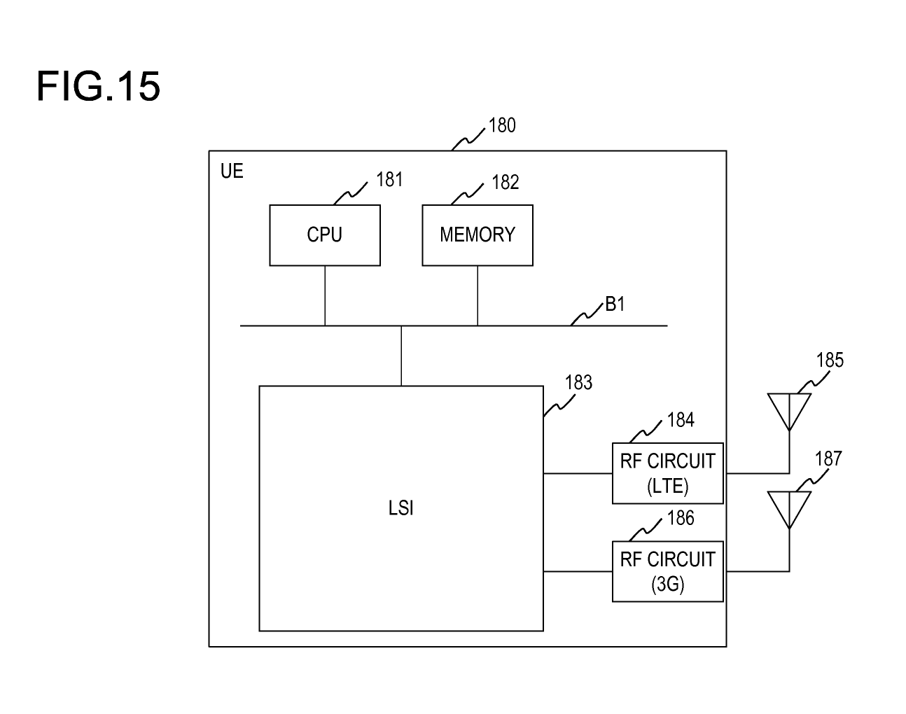

FIG. 15 is a view illustrating a hardware configuration example of a radio terminal (UE). FIG. 15 illustrates one hardware configuration example of UE 180 supporting both of LTE and 3G. The UE 180 may be used as either the UE 18A or the UE 19A illustrated in FIG. 2.

Referring to FIG. 15, the UE 180 includes a CPU 181, a memory 182 and an LSI 183, which are interconnected via a bus B1. The LSI 183 is connected with an RF circuit 184 for LTE and an RF circuit 186 for 3G. A transmitting and receiving antenna 185 is connected to the RF circuit 184 and a transmitting and receiving antenna 187 is connected to the RF circuit 186. The UE may include a microphone and a speaker (not illustrated) for a voice call.

The memory 182 may employ the same configuration as the memory 212, and stores a program executed by the CPU 181 and data used to execute the program. The memory 182 is also used as a work area of the CPU 181.

The CPU 181 executes the program to perform, for example, the procedures of radio access to a base station, a setup, and a handover. In the performance of these procedures, the CPU 181 generates a control signal. In addition, the CPU 181 generates user data (including audio data) sent to a communication partner of the UE 180. The control signal and the user data are delivered to the LSI 183.

The LSI 183 performs a digital baseband processing for the control signal and the user data, sends a baseband signal for LTE to the RF circuit 184, and sends a baseband signal for 3G to the RF circuit 186. In the meantime, the LSI 183 converts the baseband signal from the RF circuit 184 or the RF circuit 186 into a control signal or user data which is then sent to the CPU 181.

Each of the RF circuit 184 and the RF circuit 186 includes a modulation/demodulation circuit, an up-converter, a power amplifier (PA), a duplexer, a low noise amplifier (LNA) and a down-converter, as in the above-described RF circuit 25 and RF circuit 28. The antenna 185 transmits/receive an LTE radio signal and the antenna 187 transmits/receive a 3G radio signal.

The RF circuit 186 and the transmitting and receiving antenna 187 are omitted from UE (e.g., UE 18A) supporting only LTE among 3G and LTE. Conversely, the RF circuit 184 and the transmitting and receiving antenna 185 are omitted from UE (e.g., UE 19A) supporting only 3G.

The radio terminal (UE) in the second embodiment supports at least one of 3G and LTE, and includes various radio terminals such as, for example, a smartphone, a tablet terminal, and a smart meter as long as they can wirelessly communicate with base stations. The smart meter is a radio terminal which uses a sensor or a measuring device to measure a predetermined physical quantity and delivers a measurement result to other communication devices by a radio communication. The radio terminal may perform a radio communication with a base station or an access point device, and may be either mobile or fixed.

A radio terminal which can use the C-BBU 21 is not limited in its use as long as it can support at least one of LTE and 3G. In particular, RAT being used may be selected depending on the amount of data required by the radio terminal for communication.

For example, in view of the fact that the communication speed of LTE is higher than that of 3G, it is considered that a radio terminal such as the smart meter having a less amount of communication data uses 3G and a smartphone having a more amount of communication data than the smart meter uses LTE.

Setup Sequence of 3G over LTE

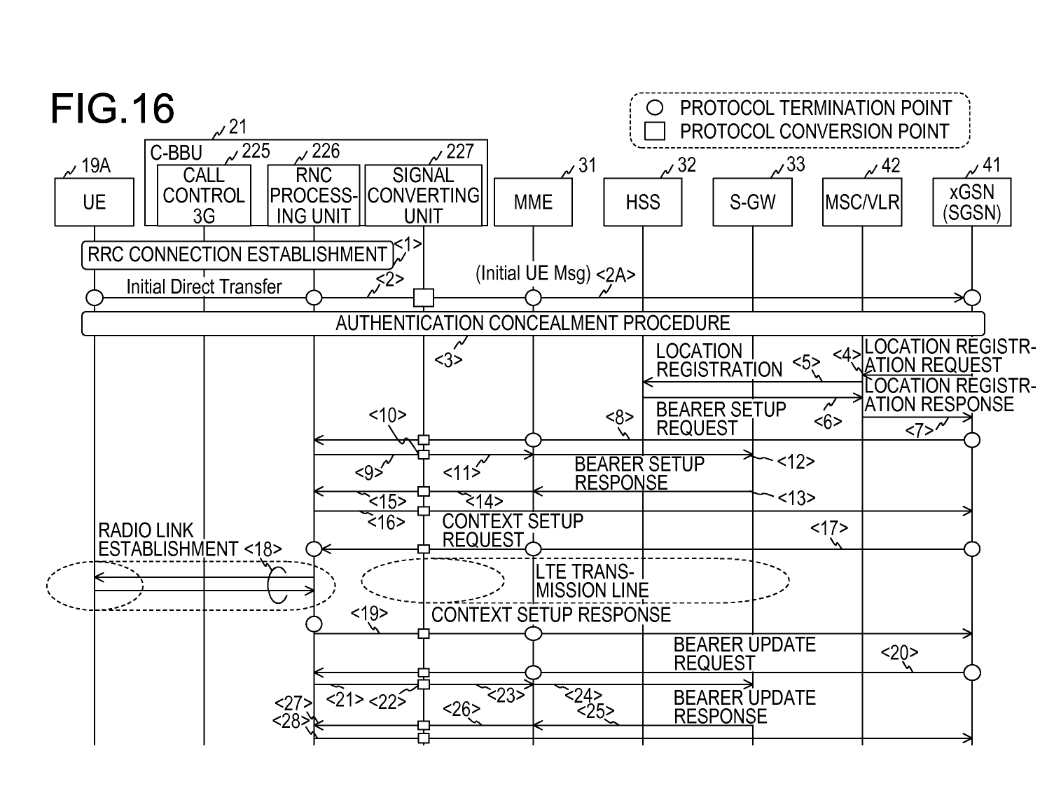

FIG. 16 is a sequence diagram illustrating an example of a setup request sequence of a “3G over LTE call” for the 3G UE 19A. Referring to FIG. 16, a UE 19A located in a cell or a sector formed by the 3G RRH 23 establishes an RRC connection with the RNC processing unit 226 (RRC) via the call control unit 225 (NodeB) of the C-BBU 21 (<1> in FIG. 16). The UE 19A is in a state of a radio connection with a 3G radio network by the establishment of the RRC connection.

Subsequently, the UE 19A transmits a control signal (Initial Direct Transfer) of a setup request bound for the xGSN 41 (<2> in FIG. 16). The setup request is received in the C-BBU 21 and converted into a signal format (protocol stack C in FIG. 12) bound for the MME 31, including an identifier (transmission instruction) of “3G over LTE,” by the downlink signal processing by the signal converting unit 227 (FIG. 10). The setup request is transmitted to the MME 31. The MME 31 transmits the setup request to the xGSN 41 according to a transmission instruction (<2A> in FIG. 16).

Upon receiving the setup request, the xGSN 41 (SGSN) performs a predetermined authentication concealment procedure with the UE 19A (<3> in FIG. 16). At this time, the control signal from the xGSN 41 to the UE 19A is protocol-converted according to the downlink signal processing by the signal converting unit 227 (FIG. 11). In addition, the control signal from the UE 19A to the xGSN 41 is protocol-converted according to the uplink signal processing by the signal converting unit 227 (FIG. 10).

Upon authenticating the UE 19A, the xGSN 41 requests the MSC/VLR 42 for a location registration of the UE 19A (<4> in FIG. 16). Upon terminating a process based on the request for location registration, the MSC/VLR 42 requests the HSS 32 for location registration of the UE 19A (<5> in FIG. 16). The HSS 32 performs the location registration of the UE 19A and returns a response message indicating the termination of the location registration to the MSC/VLR 42 (<6> in FIG. 16). Upon receiving the response message, the MSC/VLR 42 returns a location registration response message to the xGSN 41 (<7> in FIG. 16).

Then, the xGSN 41 generates and transmits a control signal of bearer setting request bound for RNC (<8> in FIG. 16). This bearer setting request is received in the C-BBU 21 via the MME 31 and reaches the RNC processing unit 226 via the signal converting unit 227. The RNC processing unit 226 holds various parameters included in the bearer setting request and returns the bearer setting request to the signal converting unit 227 (<9> in FIG. 16).

Based on a variety of information (parameters) included in the bearer setting request from the RNC processing unit 226, the signal processing unit 227 generates a bearer setting request bound for the MME 31 (<10> in FIG. 16) and transmits the generated bearer setting request to the MME 31 (<11> in FIG. 16). That is, the 3G bearer setting request is converted into the bearer setting request bound for the MME.

Upon receiving the bearer setting request, the MME 31 uses, for example, DNS (Domain Name System) to select the S-GW 33 and the P-GW 34 in order to form a communication path of a signal (user data) of the UE 19A on the core network 30. The MME 31 transmits the bearer setting request including information of the selected P-GW 34 to the selected S-GW 33 (<12> in FIG. 16).

Upon receiving the bearer setting request, the S-GW 33 sets a bearer with the P-GW 34 designated by the bearer setting request. In addition, the S-GW 33 sets a bearer (GTP-U path) between the S-GW 33 and the C-BBU 21. Thus, a user data communication line (LTE transmission line) is formed between the C-BBU 21, the S-BBU 33, and the P-GW 34 (PDN).

After setting the bearer, the S-GW 33 informs the MME 31 of a bearer setup response message (<13> in FIG. 16). The MME 31 transmits the bearer setup response to the C-BBU 21 (<14> in FIG. 16). Based on the bearer setup response from the MME 31, the signal converting unit 227 generates a bearer setup response message bound for the RNC processing unit 226, which is then sent to the RNC processing unit 226 (<15> in FIG. 16).

The RNC processing unit 226 stores information included in the bearer setup response message, if necessary, and then transmits the bearer setup response to the xGSN 41 (<16> in FIG. 16). The bearer setup response is converted into a format bound for the MME 31 according to the uplink signal processing by the signal converting unit 227, which is then sent from the MME 31 to the xGSN 41.

Upon receiving the bearer setup response, the xGSN 41 generates a control signal (message) of a context request bound for RNC and transmits the generated control signal via the MME 31 based on connection information (<17> in FIG. 16). The context request is converted by the signal converting unit 227 of the C-BBU 21 into a signal format bound for the RNC processing unit 226, which is then supplied to the RNC processing unit 226.

Upon receiving the context setting request, the RNC processing unit 226 sets a radio bearer with the UE 19A (<18> in FIG. 16). After setting the radio bearer, the RNC processing unit 226 sends a control signal (message) of a context setup response to the xGSN (<19> in FIG. 16). The context setup response is received in the xGSN 41 via the MME 31 according to the uplink signal processing by the signal converting unit 227.

Upon receiving the context setup response, the xGSN 41 generates a control signal (message) of bearer update request and transmits the generated control signal to the C-BBU 21 via the MME 31 based on connection information (<20> in FIG. 16). The bearer update request is sent to the C-BBU 21 via the MME 31 according to the same procedure and method as the bearer setting request and reaches the RNC processing unit 226 via the signal converting unit 227. The RNC processing unit 226 holds various parameters included in the bearer update request and returns the bearer update request to the signal converting unit 227 (<21> in FIG. 16).

Based on a variety of information (parameters) included in the bear update request from the RNC processing unit 226, the signal processing unit 227 generates a bearer update request bound for the MME 31 (<22> in FIG. 16) and transmits the generated bearer update request to the MME 31 (<23> in FIG. 16).

Upon receiving the bearer update request, the MME 31 transmits the bearer update request to the S-GW 33 (<24> in FIG. 16). Upon receiving the bearer update request, the S-GW 33 uses information related to the radio bearer included in the bearer update request to perform a bearer update. Thus, a user data communication path of the UE 19A formed of the radio bearer and the bearer (GTP-U path) is established.

Upon terminating the bearer update, the S-GW 33 informs the MME 31 of a bearer update response message (<25> in FIG. 16). The MME 31 transmits the bearer update response to the C-BBU 21 (<26> in FIG. 16). Based on the bearer update response from the MME 31, the signal converting unit 227 generates a bearer update response message bound for the RNC processing unit 226, which is then sent to the RNC processing unit 226 (<27> in FIG. 16).

The RNC processing unit 226 stores information included in the bearer update response message, if necessary, and then transmits the bearer update response to the xGSN 41 (<28> in FIG. 16). The bearer update response is converted into a format bound for the MME 31 according to the uplink signal processing by the signal converting unit 227, which is then sent from the MME 31 to the xGSN 41. When the xGSN 41 receives the bearer update response, the procedure of the “3G over LTE call” is ended.

According to the above-described sequence, the bearer setting request transmitted from the xGSN 41 to the RNC processing unit 226 (i.e., the bearer setting request bound for the 3G network) is converted into the bearer setting request bound for the LTE network by the signal converting unit 227. Accordingly, even for a 3G call of the UE 19A, a user data communication line is formed in the LTE network.

In addition, for a setup request from the LTE UE 18A, a normal attach procedure based on LTE is performed and an LTE call is established.

Handover from LTE to 3G

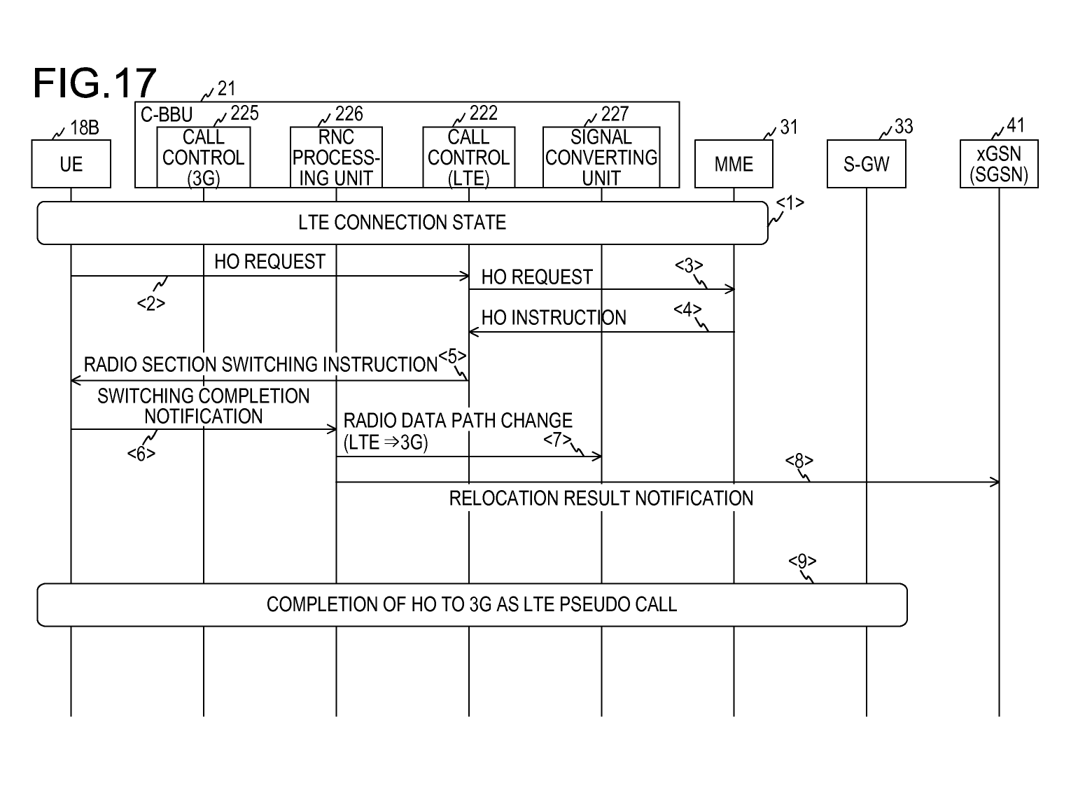

FIG. 17 is a sequence diagram illustrating an example of a procedure where a UE 18B supporting both of 3G and LTE hands over from LTE to 3G. The UE 18B establishes an LTE call via the C-BBU 21 and is in a state where it is connected to the LTE network (<1> in FIG. 17).

When deciding to perform a handover (HO) to 3G, the UE 18B transmits a handover (HO) request to the MME 31 (<2> and <3> in FIG. 17).

Upon receiving the HO request, the MME 31 transmits a handover (HO) instruction to the call control unit 222 of the C-BBU 21 (<4> in FIG. 17).

Upon receiving the HO instruction, the call control unit 222 sends a radio section switching instruction to the UE 18B (<5> in FIG. 17). Upon receiving the switching instruction, the UE 18B destructs a radio section (LTE radio link) with the call control unit 222 (eNodeB) and establishes a 3G radio link (not illustrated) by establishing an RRC connection with the RNC processing unit 226 via the call control unit 225 of the C-BBU 21.

Once the radio link is established, the UE 18B sends a switching completion notification on a radio section to the RNC processing unit 226 (<6> in FIG. 17). The RNC processing unit 226 sends change notification on a radio data path to the signal converting unit 227 (<7> in FIG. 17). According to the change notification, the signal converting unit 227 rewrites an entry stored in the table T1 such that a control signal according to the UE 18B is transmitted to the xGSN 41 via the MME 31.

The RNC processing unit 226 sends a relocation result notification associated with the handover to the xGSN 41 (<8> in FIG. 17). The relocation result notification is converted into a signal format bound for the MME 31 according to the uplink signal processing by the signal converting unit 227 (FIG. 10), which is then transmitted to the MME 31. The MME 31 transmits the relocation result notification to the xGSM 41 according to a transmission instruction included in a control signal of the relocation result notification.

As described above, when the handover from LTE to 3G is performed in the C-BBU 21, an LTE pseudo call is established. For the U-plane, since there is compatibility between 3G and LTE, a user data communication line (GTP-U path) established in the LTE attach procedure can continue to be used after the handover to 3G.

According to the second embodiment, in the signal converting unit 227, the control signal bound for the xGSN 41 is converted into a signal bound for the MME 41, which includes the control signal and a transmission instruction (the identifier of “3G over LTE”). In other words, a signal bound for the MME 41, which includes the control signal and transmission instruction bound for the xGSN 41, is generated. Thus, the signal bound for the xGSN 41 can be sent to the xGSN 41 via the MME 31. Accordingly, it is possible to avoid a link connection between the C-BBU 21 and the xGSN 41. That is, a link between RNC and SGSN can be reduced.

In addition, in the establishment procedure of LTE pseudo call, a user data communication line of U-plane is formed on the LTE network instead of the 3G network. Thus, a management and monitoring of GTP-U according to a subordinate radio terminal of the C-BBU 21 becomes easy. In addition, when the handover from LTE to 3G is performed in the C-BBU 21, since reestablishment of a GTP-U path (bearer) can be avoided, it is possible to simplify the handover procedure.

Further, since a negotiation between eNodeB and NodeB in the handover from LTE to 3G is performed in the C-BBU 21, it is possible to reduce the time required for the handover.

The configurations of the above-described embodiments may be used in combination if necessary.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A network control method of a communication system into which a first node supporting a first radio communication standard in a first network, a second node supporting a second radio communication standard in a second network, the second node connecting with the first node, and a communication apparatus connected with the first node via a link are formed, the network control method comprising:
transmitting a first control signal bound for the first node, associated with a first terminal supporting the first radio communication standard, to the first node via the link;
generating a second control signal bound for the first node, the second control signal including a third control signal bound for the second node, associated with a second terminal supporting the second radio communication standard, and a fourth control signal having a transmission instruction for transmitting the third control signal to the second node; and
transmitting the second control signal to the first node via the link, by the communication apparatus.

2. The network control method according to claim 1, wherein the third control signal includes a setup request received from the second terminal.

3. The network control method according to claim 2, further comprising:
when a first request to establish a communication line of a signal transmitted from the second terminal is received from the second node that have received the setup request via the first node,
converting the first request into a second request bound for the first node for establishing the communication line on the first network; and
transmitting the second request to the first node via the link, by the communication apparatus.

4. The network control method according to claim 1, further comprising:
when the first terminal which is connected with the communication apparatus, the first terminal communicating on a basis of the first radio communication standard, executes handover to a communication based on the second radio communication standard,
generating a fifth control signal bound for the first node, the fifth control signal including a sixth control signal bound for the second node, associated with the first terminal, and a seventh control signal having a transmission instruction for transmitting the sixth control signal to the second node, and
transmitting the fifth control signal to the first node via the link, by the communication apparatus.

5. A communication apparatus comprising:
an interface connected with a first node supporting a first radio communication standard via a link in a first network, the first node being connected with a second node supporting a second radio communication standard in a second network; and
a controller configured: to transmit a first control signal bound for the first node, associated with a first terminal supporting the first radio communication standard, to the first node via the link; to generate a second control signal including a third control signal bound for the second node, associated with a second terminal supporting the second radio communication standard, and a fourth control signal having a transmission instruction for transmitting the third control signal to the second node; and to transmit the second control signal to the first node via the link.

6. The communication apparatus according to claim 5, wherein the third control signal includes a setup request received from the second terminal.

7. The communication apparatus according to claim 6, wherein
when a first request to establish a communication line of a signal transmitted from the second terminal is received from the second node that have received the setup request via the first node,
the controller converts the first request into a second request bound for the first node for establishing the communication line on the first network, and transmits the second request from the interface to the first node via the link.

8. The communication apparatus according to claim 5, wherein
when the first terminal communicates on a basis of the first radio communication standard, and executes handover to a communication based on the second radio communication standard,
the controller generates a fifth control signal bound for the first node, the fifth control signal including a sixth control signal bound for the second node, associated with the first terminal, and a seventh control signal having a transmission instruction for transmitting the sixth control signal to the second node, and transmits the fifth control signal to the first node via the link.

9. A communication system comprising:
a first node configured to support a first radio communication standard in a first network
a second node configured to support a second radio communication standard in a second network, the second node connecting with the first node; and
a communication apparatus configured to include:
an interface connected with the first node via a link; and
a controller configured: to transmit a first control signal bound for the first node, associated with a first terminal supporting the first radio communication standard, to the first node via the link; to generate a second control signal including a third control signal bound for the second node, associated with a second terminal supporting the second radio communication standard, and a fourth control signal having a transmission instruction for transmitting the third control signal to the second node; and to transmit the second control signal to the first node via the link.
